(19) United States
(12) Patent Application Publication
(10) Pub. No.: US 2024/0251486 A1
(43) Pub. Date: Jul. 25, 2024

(54) INDUCTION BASED INDUSTRIAL HEATING SYSTEM

(71) Applicant: Brandon Michael Cappis, Lacombe (CA)

(72) Inventor: Brandon Michael Cappis, Lacombe (CA)

(21) Appl. No.: 18/159,112

(22) Filed: Jan. 25, 2023

(51) Int. Cl. H05B 6/36; H05B 6/10

(52) U.S. Cl. CPC H05B 6/36; H05B 6/10

(57) ABSTRACT

An industrial heating system that is configured to be employed in a variety of industrial applications such as but not limited to processing and superheating wherein the present invention employs induction heating technology for a heat source. The present invention includes a power supply wherein the power supply is operably coupled to an electronic oscillator. The electronic oscillator is operably coupled to an electromagnet and transmits a high frequency alternating current to the electromagnet. A coil member is operably coupled to the electromagnet and the current received therefrom produces heat in the coil member. The coil member is manufactured from a suitable metal such as but not limited to ferrous metal or copper. The present invention is configurable to be deployed in a superheater and replaced conventional fuel oils that provide a heat source to heat a fluid being passed therethrough.

### FIELD OF THE INVENTION

The present invention relates generally to industrial heating systems, more specifically but not by way of limitation, an industrial superheater or line heater that is employed for various applications wherein the

### BACKGROUND

A superheater is a device used to convert saturated steam or fluids into superheated steam also known as dry steam. There are three types of superheaters: radiant, convection, and separately fired. A superheater can vary in size and capacity and are employed an a variety of industrial applications such as but not limited to oil and gas processing and drilling. There are three types of superheaters that are currently utilized for various applications. A radiant superheater is placed directly in radiant zone of the combustion chamber near the water wall so as to absorb heat by radiation. A convection superheater is located in the convective zone of the furnace usually ahead of economizer in the path of the hot flue gases. These are also called primary superheaters. A separately fired superheater is a superheater that is placed outside the main boiler, which has its own separate combustion system. This superheater design incorporates additional burners in the area of superheater pipes. This type of superheater is rarely if ever used, because of poor efficiency and steam quality that is not better than other superheater types.

A superheater is a coiled-shaped heat exchanger which is usually used in boilers to convert saturated steam to dry steam/superheated steam. In power generation plants, superheated steam is used for the production of electricity. A boiler is different from a superheater as a boiler uses both latent and sensible heat to raise the temperature of the fluid, but a superheater uses only sensible heat to increase the enthalpy of the liquid. The size of a superheater varies between ten feet to one hundred feet. Superheaters typically employ natural gas or fuel oil as a heat source for operation thereof. While conventional fuels have been effective, it is desirable within the scope of climate change to explore and implement alternate fuel sources that assist in the goal of reduction of carbon emissions.

Accordingly, there is a need for an industrial heating system that can be deployed in various applications wherein the industrial heating system utilizes induction heating to provide heating of the fluids.

### SUMMARY OF THE INVENTION

It is the object of the present invention to provide an induction base industrial heating system that is configured to provide heating of fluid traversing through a pipe or a portion of processing equipment wherein the present invention includes an electromagnet and an electronic oscillator.

Another object of the present invention is to provide a system configured to provide rapid heating of fluids being utilized in an industrial application wherein the present invention includes conduction coils.

A further object of the present invention is to provide an induction base industrial heating system that is configured to provide heating of fluid traversing through a pipe or a portion of processing equipment wherein the induction coils can be disposed in a single location or surroundably mounted to a portion of piping.

Yet a further object of the present invention is to provide a system configured to provide rapid heating of fluids being utilized in an industrial application wherein the induction coils are provided in various lengths to accommodate the application and equipment associated therewith.

Still another object of the present invention is to provide an induction base industrial heating system that is configured to provide heating of fluid traversing through a pipe or a portion of processing equipment wherein the present invention further includes a power supply operably coupled to the electronic oscillator.

An additional object of the present invention is to provide a system configured to provide rapid heating of fluids being utilized in an industrial application wherein the heating elements of the present invention can heat fluids static in a tank or traversing through pipes.

Yet a further object of the present invention is to provide an induction base industrial heating system that is configured to provide heating of fluid traversing through a pipe or a portion of processing equipment wherein the coils of the present invention can be manufactured from copper or aluminum.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of exemplary process piping employing the present invention; and

FIG. 2 is an exemplary line heater of the present invention; and

FIG. 3 is a top view of process lines having the coils of the present invention mounted thereto; and

FIG. 4 is a side view of process lines having the coils of the present invention mounted thereto; and

FIG. 5 is an exemplary fracking superheater of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an industrial heating system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

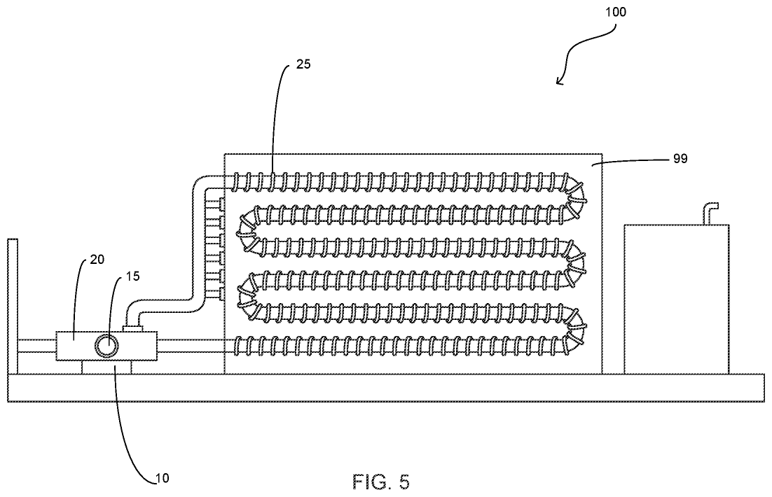

Referring in particular to the Figures submitted herewith, an exemplary industrial heating system 100 deployed in a fracking superheater is illustrated herein in FIG. 5. The industrial heating system 100 includes a power supply 10 wherein the power supply 10 is a conventional electric power supply that is operably coupled to a suitable power source. It is contemplated within the scope of the present invention that the power supply 10 could be either a 120 volt or 240 volt power supply. The power supply 10 is operably coupled to an electronic oscillator 15. The electronic oscillator 15 is a conventional oscillator that transmits a high frequency alternating current to the electromagnet 20. The electromagnet 20 produces an alternating magnetic field wherein this alternating magnetic field is transmitted to the coil member 25. Coil member 25 is manufactured from a suitable durable metal such as but not limited to ferrous metals, copper or aluminum. The coil member 25 is circumferentially surrounded to the pipes of the exemplary superheater 99. It is contemplated within the scope of the present invention that the coil member 25 could be circumferentially mounted to all or a portion of the pipes.

The alternating magnetic field received by the coil member 25 results in the production of heat and it should be understood within the scope of the present invention that the industrial heating system 100 could be utilized to produce heat up to 2500 degrees Celsius. Heat generated depends on the initial coil current, number of turns of the coil member 25, frequency of the electronic oscillator 15 and the electrical resistivity of the material utilized to manufacture the coil member 25. It should be understood within the scope of the present invention that various configurations of the superheater 99 could be provided depending upon the intended application.

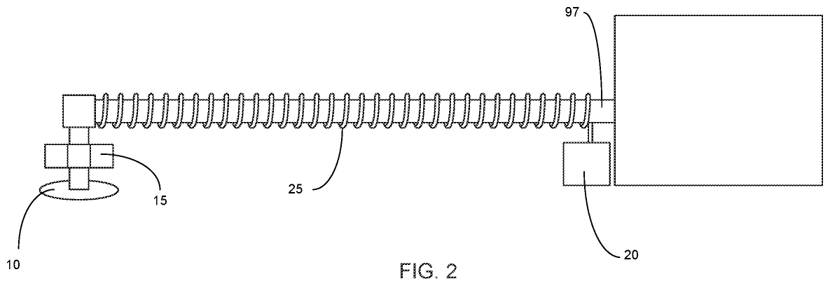

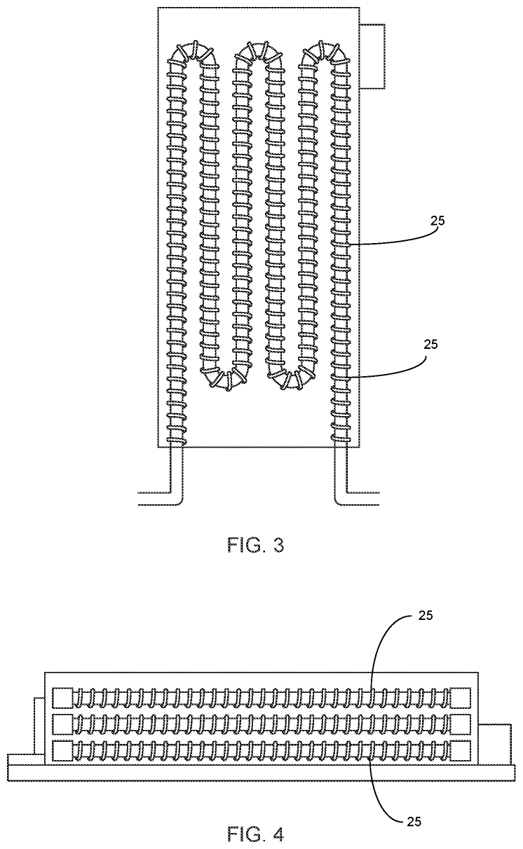

Referring in particular to FIG. 2, the industrial heating system 100 is deployed in a line heater application. In this application the power supply 10, electronic oscillator 15, electromagnet 20 and coil member 25 are deployed to heat a portion of a line 97 wherein the line has a fluid traversing therethrough. It should be understood within the scope of the present invention that FIG. 2 is an exemplary line heater application and that alternate configurations of the industrial heating system 100 for a line heater application are contemplated within the scope of the present invention. FIGS. 3 and 4 illustrated herein provide exemplary alternate configurations of line heater applications contemplated within the scope of the industrial heating system 100.

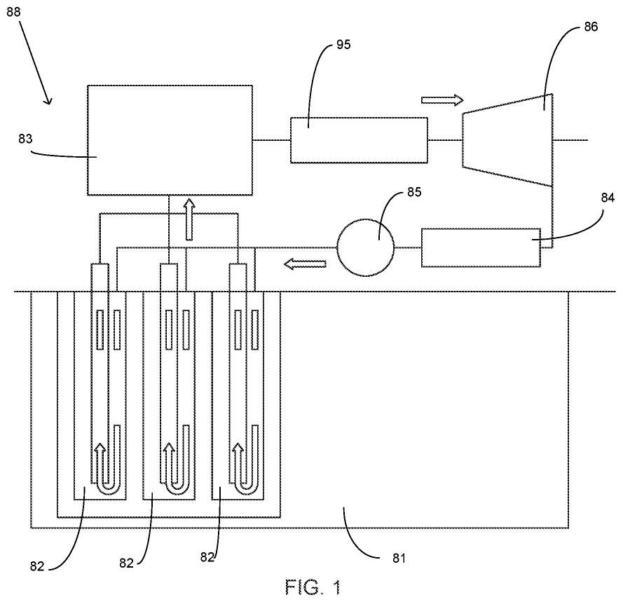

FIG. 1 submitted herewith provides a diagrammatic view of a geothermal system wherein the superheater 95 forming a part thereof is configured as described herein for the exemplary superheater 99 illustrated herein in FIG. 1. The geothermal system 88 illustrated in FIG. 1 is a conventional geothermal system having a well 81 with downhole coaxial heat exchangers 82, steam generator 83, pump 85, condenser 84, turbine 86 and having superheater 95 of the present invention forming an operable part thereof. The superheater 95 is operably coupled to the turbine 86 and the fluid exiting the superheater 95 is employ to operate the turbine 86.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An industrial heating system that is configured to be employed in a variety of industrial applications wherein the industrial heating system comprises:
a power supply, an electronic oscillator, said electronic oscillator being operably coupled to said power supply, said electronic oscillator operable to transmits high frequency alternating current;
an electromagnet, said electromagnet being operably coupled to said electronic oscillator, said electromagnet configured to receive the high frequency alternating current from said electronic oscillator and produce an alternating electromagnetic field;
at least one coil member, said at least one coil member being operably coupled to said electromagnet, said at least one coil member operable to produce heat from the alternating electromagnetic field received from the electromagnet; and
wherein the at least one coil member can be mounted in a first position and a second position.

2. The industrial heating system that is configured to be employed in a variety of industrial applications as recited in claim 1, wherein the industrial heating system is deployed within a superheater.

3. The industrial heating system that is configured to be employed in a variety of industrial applications as recited in claim 2, wherein in the first position of the at least one coil member the at least one coil member is proximate a bottom of a vessel so as to heat a static fluid disposed therein.

4. The industrial heating system that is configured to be employed in a variety of industrial applications as recited in claim 2, wherein in the second position of the at least one coil member the at least one coil member is circumferentially mounted to at least a portion of a pipe wherein the pipe has fluid passing therethrough.

5. The industrial heating system that is configured to be employed in a variety of industrial applications as recited in claim 2, wherein the at least one coil member is manufactured from a metal selected from one of a group consisting of: ferrous metal, copper or aluminum.
